(19) United States
(12) Patent Application Publication
(10) Pub. No.: US 2008/0015938 A1
(43) Pub. Date: Jan. 17, 2008

(54) Promotions system and method

(75) Inventors: Aneace Haddad, Les Arcs (FR); Ramkumar Kalpathy Balasubramaniam, Singapore (SG)

Correspondence Address: BANNER & WITCOFF, LTD., 1100 13th STREET, N.W., SUITE 1200, WASHINGTON, DC, 20005-4051, US

(73) Assignee: Welcome Real-Time Pte., Ltd., Singapore (SG)

(21) Appl. No.: 11/822,537

(22) Filed: Jul. 6, 2007

Related U.S. Application Data
(60) Provisional application No. 60/819,810, filed on Jul. 11, 2006.

(51) Int. Cl. G06Q 30/00; G06F 17/30; G06F 17/40; G06Q 10/00

(52) U.S. Cl. 705/14

(57) ABSTRACT

A promotional system and method for point-of-sales terminals for a vendor, that performs steps including: i) accessing sales data representing previous sales transactions of a customer of the vendor with different merchants; ii) generating, based on said sales data, relationship data representing one or more attributes of said merchants; iii) accessing configuration data including data representing one or more criteria for providing one or more promotions of one or more of said merchants to said customer based on the value of said attributes; iv) selecting, based on said relationship data and said configuration data, one or more of said merchants with at least one of said attributes that satisfy said parameters; v) accessing promotions data representing said one or more promotions for said selected merchants; and vi) generating, based on said promotions data, a record of said one or more promotions for said customer.

### FIELD

The present invention relates to a promotions system and method, and in particular, but not being limited to, a system and method for facilitating cross-promotion of commercial promotions or offers from different merchants.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

Many merchants cooperate to obtain benefits from cross-promotion of their businesses. Typically, such cross promotions need to be setup manually and are not targeted towards specific customers. Merchants participating in a cross-promotions scheme have used a common parameter, such as geography (e.g. their business are located in the same city or same mall) or shareholders (e.g. a holding company having stakes in 2 merchant chains), as a means of defining the connection between the merchants to qualify for cross-promotions. For example, a book-store may setup a cross-promotions arrangement with a nearby coffee shop or one within the bookshop premises. Such cross-promotions are not targeted to specific types of customers, but are applicable to all customers who have spent a certain amount with the merchant. Also, such cross-promotions require two or more unrelated merchants to work together and agree to do the cross-promotion on an ongoing basis, and ongoing active communication and promotion to customers can be costly.

Another way to conduct cross-promotions involves data mining techniques, which rely on the use of a business intelligence server that analyses the transaction data of customers. Promotion coupons are subsequently mailed to the customer's billing address along with the monthly statements. This approach is complex and still requires an offer to be actively communicated to the customer.

Collaborative filtering (CF), or folksonomy, is the method of making automatic predictions concerning the interests of a user by collecting relevant information from many users. CF methods are usually based on the following steps:
identifying users who have the same rating patterns as the current user, and
using the ratings from the ‘like-minded’ users identified in step 1 to calculate a prediction for the active user.

CF techniques may be based on observations of a user's normal behaviour. This may involve observation of what the current user has done together with what all users have done and using that data to predict the users' behaviours in the future or predict how a user might behave. The resulting predictions are then filtered through a set of logic rules. For example, it is not useful to use CF techniques to offer to sell to someone a music compact disc (CD) if they have already bought that CD, so a logic rule prevents the offer.

The sheer number of items in individual product categories (e.g. music CDs, movies, books, newspapers, web pages) have become so large that people have difficulty viewing them all and selecting relevant items. Existing scoring or rating systems that take an average of the preferences of all users are often unhelpful because these systems ignore the requirements of individual users, and do not perform well where there is a large variation in interest. For example, people who order books from an Internet bookshop implicitly express their preference for the books they buy over the books they do not buy. All the customers who have bought a particular book are likely to have similar preferences for other books as well. This concept of association has been used in the Amazon.com website, where each time a person purchases a specific book they are provided with a list of related books that were bought by other people who purchased the same book. CF theory has not been applied beyond a comparatively narrow form of single product marketing.

It is therefore desired to address one or more of the above, or to at least provide a useful or effective system and method for cross-promotions.

### SUMMARY

According to the present invention there is provided a promotional system including a point-of-sales terminal for a vendor, said terminal being configured to:
i) access sales data representing previous sales transactions of a customer of said vendor with different merchants;
ii) generate, based on said sales data, relationship data representing one or more attributes of said merchants;
iii) access configuration data including data representing one or more criteria for providing one or more promotions of one or more of said merchants to said customer based on said attributes;
iv) select, based on said relationship data and said configuration data, one or more of said merchants with at least one of said attributes that satisfy said criteria;
v) access promotions data representing said one or more promotions for said selected merchants; and
vi) generate, based on said promotions data, a record of said one or more promotions for said customer.

The present invention also provides a promotional method including:
i) accessing sales data representing previous sales transactions of a vendor's customer with different merchants;
ii) generating, based on said sales data, relationship data representing one or more attributes of said merchants;
iii) accessing configuration data including data representing one or more criteria for providing one or more promotions of one or more of said merchants to said customer based on said attributes;
iv) selecting, based on said relationship data and said configuration data, one or more of said merchants with at least one of said attributes that satisfy said criteria;
v) accessing promotions data representing said one or more promotions for said selected merchants; and
vi) generating, based on said promotions data, a record of said one or more promotions for said customer.

The present invention also provides computer readable code for configuring a point-of-sales device to perform a method as described above.

### BRIEF DESCRIPTION OF THE DRAWINGS

Preferred embodiments of the present invention are herein described, with reference to the accompanying drawings, wherein:

FIG. 1 is a block diagram showing the components of the promotions system;

FIG. 2 is a flow diagram of a promotions process performed by the system;

FIG. 3 is a flow diagram of a customer update process performed by the system;

FIG. 4 is a flow diagram of a relationship analysis process performed by the system;

FIG. 5 is a flow diagram of a selection process performed by the system;

FIG. 6 is a flow diagram of a presentation process performed by the system;

FIG. 7 is an example of a coupon generated by the promotions system;

FIG. 8 is a block diagram showing an application of the promotions system; and

FIG. 9 shows a collection of Venn diagrams representing different exemplary comparisons of minimum match criteria in the frequency category.

### DETAILED DESCRIPTION OF THE PREFERRED EMBODIMENTS

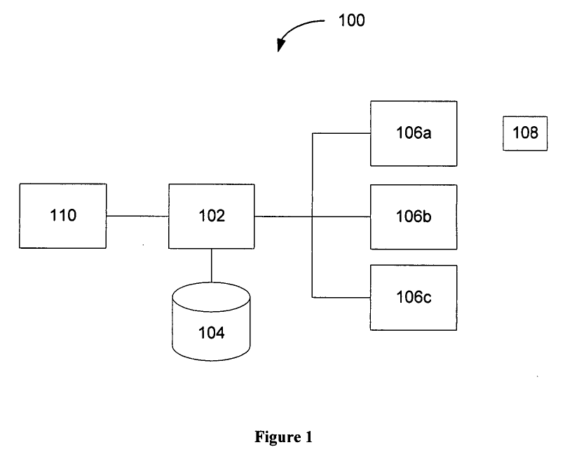

The promotions system 100, as shown in FIG. 1, includes a promotions server 102 that communicates with a database 104. The database 104 includes relational database such as MySQL (http://www.mysql.org), or it may be made up of one or more structured data files and/or flat data files. The database 104 may be located on the promotions server 102, or alternatively, may be located physically remote from the server 102. The promotions server 102 is a standard computer (e.g. that provided by IBM Corporation <http://www.ibm.com>) running a standard operating system (such as Windows Server™ or Unix) that is configured to communicate with one or more point-of-sales (POS) terminals 106a, 106b and 106c via a communications network (such as the Internet, a POTS telephone network, or a radio-based telecommunications network). Preferably, the communications network is part of the existing communications infrastructure of an electronic payments system.

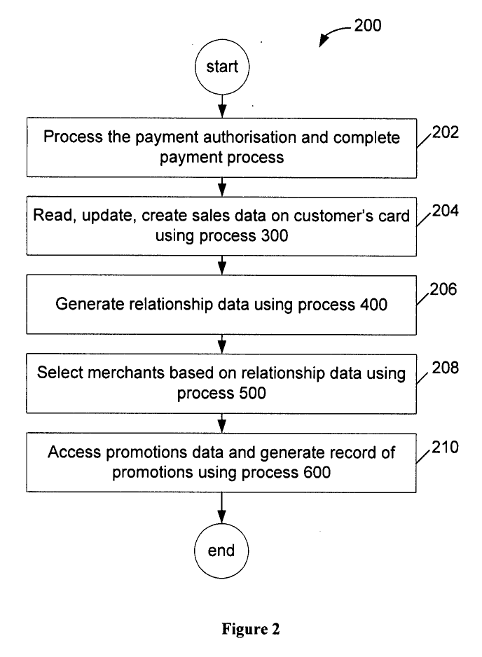

The promotions server 102 sends and receives configuration data and promotions data to and from each of the POS terminals 106a, 106b and 106c. Each POS terminal 106a, 106b and 106c may be used by a different merchant, or by different sales departments of a particular merchant (e.g. in a department store). Each POS terminal 106a, 106b and 106c includes a processor and one or more control modules that control the processor to perform the processes described in FIGS. 2 to 6. The modules in the POS terminals are provided by computer program code, for example in languages such as C or C++. Those skilled in the art will also appreciate that the processes performed by the modules and by the server 102 can also be executed at least in part by dedicated hardware circuits, e.g. Application Specific Integrated Circuits (ASICs) or Field-Programmable Gate Arrays (FPGAs).

The promotions server 102 performs a registration process. This involves the promotions server 102 receiving configuration data (including merchant data) and promotions data from each of the different merchants, and receiving configuration data (including vendor data) from each of the different vendors. A merchant refers to a person or entity that provides or offers a promotion for distribution to customers. A vendor refers to a person or entity that distributes the promotions of one or more different merchants. The promotions system 100 allows a single person/entity to be both a vendor and a merchant, as defined above.

The promotions server 102 receives configuration data and promotions data from a merchant via one of the POS terminals 106a, 106b and 106c, or alternatively, via a remote computer terminal 110 that communicates with the promotions server 102 (e.g. via the communications network). Configuration data and promotions data may be entered by a user using a data entry interface of the terminal 106a, 106b, 106c or I 10 (e.g. a keyboard, keypad or mouse for data entry, or an optical scanner device that reads a written or printed representation of an identifier (e.g. a barcode) and then retrieves predefined configuration data and promotions data stored in a database). The configuration data and promotions data for each merchant is stored in the database 104, or alternatively, in the memory of the POS terminal 106a, 106b and 106c.

A merchant is responsible for (i) defining a promotion and (ii) defining which merchant categories can distribute the defined promotions. For example, a Cosmetic-category merchant could define a 10%-off cross-promotion and then go on to specify that this cross-promotion is to be distributed by Petrol, Grocery, Dining & Fast Food, and GM Discount stores, but not other Cosmetics or Fashion stores. The configuration data provided by a merchant includes merchant data defining various configuration parameters for that merchant, which includes:
merchant identity data representing a unique identifier for the merchant;
merchant category data representing, based on several predefined categories of merchants, at least one of these categories related to the type of goods or services provided by the merchant; and

merchant rules data representing one or more of the predefined categories related to the goods or services provided by a vendor that are permitted to provide (i.e. distribute) the promotions offered by that merchant.

TABLE 1

| | | | Dining | | Fashion | |
|---|---|---|---|---|---|---|
| | | | & Fast | | & Dept | GM |
| | Petrol | Grocery | Food | Cosmetics | store | Discount |
| Merchant | 1 | 1 | 1 | 0 | 0 | 1 |

Table 1 is an exemplary representation of the merchant rules data for a particular merchant. There are 6 predefined categories of merchants in the top row of Table 1, including the Petrol, Grocery, Dining & Fast Food, Cosmetics, Fashion & Department stores, and GM Discount categories. The bottom row of Table 1 contains values representing one or more categories of vendors permitted to distribute a promotion offered by the merchant. In Table 1, a value of “1” for a category represents that a vendor of that category is permitted to distribute the merchant's promotions. A value of “0” for a category represents that a vendor of that category is not permitted to distribute the merchant's promotions. In Table 1, vendors classified as belonging to the Petrol, Grocery, Dining & Fast Food or GM Discount categories can distribute the merchant's promotions.

Promotions data includes description data for each of the promotions offered by the merchant. A promotion includes any commercial offer, a monetary reward or a discount for a sales transaction (e.g. with the merchant offering the promotion). Description data for a promotion includes data representing text or graphics for communicating the nature or details of the promotion to a customer (e.g. when printed onto a paper record, such as a coupon).

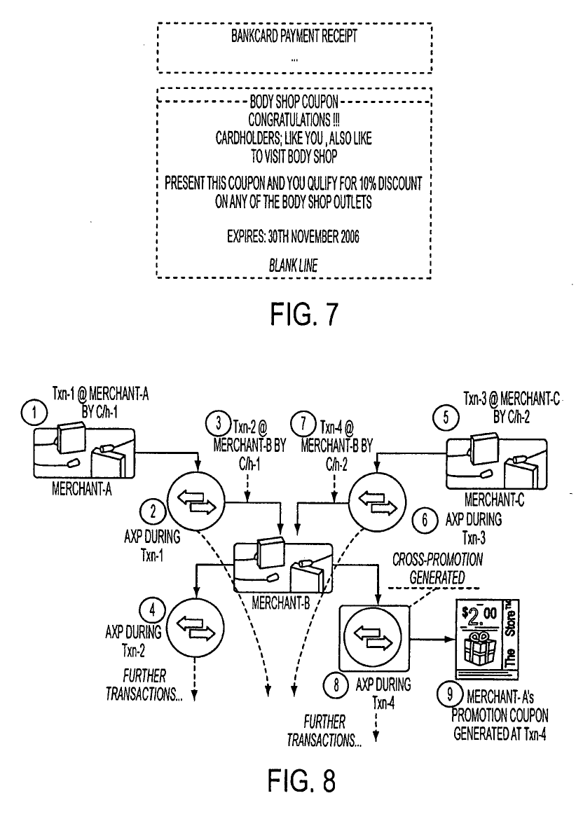

FIG. 7 is an example of a coupon generated based on the promotions data for a merchant. Preferably, one or more promotional coupons are printed at the very instant of payment at the payment accepting device along with a receipt for the payment transaction. For example, the coupon shown in FIG. 7 relates to a cross-promotional Body Shop coupon along with a traditional bankcard payment receipt.

The POS terminal 106a, 106b and 106c receives configuration data from a vendor (e.g. entered by a user using a data entry interface of the terminal 106a, 106b and 106c). The vendor data is stored in the memory of each POS terminal 106a, 106b and 106c, but alternatively, the vendor data can be stored in the database 104.

A vendor is responsible for defining what kind of cross-promotions can be distributed at its outlets. For example, a vendor who belongs to the Fast Food category might prefer not to run cross-promotions with other Fast Food merchants who are competitors, but rather, would like to have cross-promotions with Petrol, Grocery, Cosmetics, Fashion & Department stores and GM Discount merchants. The configuration data provided by a vendor includes vendor data defining various configuration parameters for that vendor, which includes:
vendor identity data representing a unique identifier for the vendor;
vendor category data representing at least one of the predefined categories related to the type of goods or services provided by the vendor; and

vendor rules data representing one or more of the predefined categories, wherein the vendor provides only promotions of those merchants associated with the categories defined in the merchant category data and vendor rules data.

TABLE 2

| | | | Dining | | Fashion | |
|---|---|---|---|---|---|---|
| | | | & Fast | | & Dept | GM |
| | Petrol | Grocery | Food | Cosmetics | store | Discount |
| Vendor | 1 | 1 | 0 | 1 | 1 | 1 |

Table 2 is an exemplary representation of the vendor rules data for a particular vendor, which includes the same predefined categories from Table 1. The bottom row of Table 2 contains values representing the one or more categories of merchants. The vendor will distribute the promotions for only merchants belonging to a category with a value of “1”.

In addition to the vendor data, the configuration data supplied by each vendor may include criteria data representing one or more of the following parameters for the promotions system 100 to determine whether the vendor should distribute a merchant's promotions to a customer:
transaction limit data representing a minimum number of sales transactions between the vendor's customers and a merchant before the vendor offers promotions from that merchant to the vendor's customers (i.e. the minimum number of customer sales transactions for a merchant to qualify for a cross-promotion). This parameter allows the relationship data of a vendor to be populated with sufficient transactions before analysis begins and promotions (or recommendations) are printed for a customer;
selection limit data representing a maximum number of said merchants for selection to review whether promotions from these merchants are relevant to (and thus should be provided to) the customer (e.g. the Top-5, Top-8 or Top-10 merchants);
frequency match data representing a first threshold number for comparison with the values represented by frequency data for merchants in a vendor's relationship data. For a customer to be “relevant” in the frequency category and thus qualify for cross-promotions, the sales data for that customer may need to include a minimum number (determined by the frequency match data) of merchants from the Top[n] merchants in the frequency category based on the vendor's relationship data. For example, a customer's sales data may need to include 3 out of Top-5 frequency-merchants selected from the vendor's relationship data for the customer to be offered promotions;
spend match data representing a second threshold number for comparison with the values represented by the cumulative spend data for merchants in a vendor's relationship data. For a customer to be “relevant” in the amount category and thus qualify for cross-promotions, the customer's sales data may need to include a minimum number (determined by the spend match data) of merchants from the Top[n] merchants in the amount category based on the vendor's relationship data. For example, a customer's sales data may need to include 2 out of Top-5 amount-merchants selected from the vendor's relationship data for the customer to be offered promotions; and
recency match data representing a third threshold number for comparison with the values represented by the recency data for merchants, in a vendor's relationship data. For a customer to be “relevant” in the recency category and thus qualify for cross-promotions, the customer's sales data may need to include a minimum number (determined by the recency match data) of merchants from the Top[n] merchants in the recency category based on the vendor's relationship data. For example, a customer's sales data may need to include 4 out of Top-5 recency-merchants selected from the vendor's relationship data for the customer to be offered promotions.

Merchant and vendor registration typically consists of setting up some general cross-promotion coupons with merchant categories and some transaction parameters that form the input for processing a vendor's relationship data. For example, registration may involve selecting parameters such as the merchant categories with whom the merchant prefers to run cross-promotions. This is part of a merchant's role. The promotions server 102 then automatically marries the merchant's preferences (from the merchant data) with the vendor's preferences (from the vendor data). For each of the vendors, the server 102 processes the merchant data for each of the different merchants. If the merchant's category is allowed at this vendor, then a check is performed to verify that this merchant allows this vendor's category to distribute that merchant's promotions. If both the checks are passed, the promotions data for each of the allowed merchants are combined and transmitted to the relevant vendor's POS terminal (e.g. either 106a, 106b or 106c) for storage on the POS terminal. An example of this matching process is described with reference to Table 3.

TABLE 3

| | | | Dining | | Fashion | |
|---|---|---|---|---|---|---|
| | | | & Fast | | & Dept | GM |
| | Petrol | Grocery | food | Cosmetics | store | Discount |
| Merchant | 1 | 1 | 1 | 0 | 0 | 1 |
| Vendor | 1 | 1 | 0 | 1 | 1 | 1 |

Table 3 is shows a comparison of the merchant rules data (from Table 1) and vendor rules data (from Table 2). Assuming that the merchant in Table 3 belongs in the Cosmetics category, and the vendor in Table 3 belong in the Dining & Fast Food category, the vendor (e.g. a Fast-Food merchant) allows cross-promotions with Cosmetics merchants. From this analysis, the promotions system 100 can generate cross-promotions for merchants in the Cosmetics category for the vendor's customers. As the merchant also allows Fast Food outlets to distribute its promotions, the merchant's cross-promotions can be printed for the vendor's customers.

The cross-promotion coupons are generated based on the promotions data of the relevant merchants, and are printed only for the targeted customers by matching the customer's profiles and shopping behaviour. In this way, not all customers of the vendor will receive all the coupons but specific cross-promotions for targeted customers that are determined by the promotions system 100 based on the relationship data, as explained below. The promotions system 100 can therefore maximise the benefits for merchants as their cross-promotions are targeted and are therefore more effective.

Vendors who are registered can configure their POS terminal 106a, 106b and 106c to query the promotions server 102 to access the promotions data on a predetermined basis (e.g. at the end of each day), so that each POS terminal can retrieve new promotions or changes to existing promotions data in a timely manner.

Each customer interacting with the promotions system 100 is provided with a different client device 108 that is unique to each customer. Each client device 108 interfaces with a POS terminal 106a, 106b and 106c to perform a sales transaction between the customer and the merchant. A client device 108 may be an electronic chip card (or an IC-Card, including bank cards and credit cards), magnetic stripe card, or contactless payment device (such as a Near-Field Communication (NFC) enabled mobile phone or a standard personal computer enabled for internet payment). Typically, each client device 108 includes an integrated electronic chip and may be an EMV-enabled payment card. EMV is an acronym for the specifications issued by EMVCo, LLC covering the operation of smartcard payment cards. Vendors also often refer to being “EMV Approved” when their products have been certified as having passed tests to ensure compliance with these specifications. However, the present invention is not limited to EMV approved products.

Each client device 108 may include internal memory for storing data. The client device 108 collects and stores sales data relating to the sales transaction at each of the one or more merchants where the customer has previously carried out a sales transaction. Alternatively, the sales data of a customer may be stored on the database 104, which could be later accessed and updated based on client identity data (representing a unique identifier for a particular customer) stored on a customer's client device 108.

A customer purchases items from the vendor, and the details of that transaction are recorded as sales data on the customer's client device. The vendor may offer promotions provided by other merchants as part of that customer's transaction with the vendor. The vendor for a particular transaction may be a merchant in another transaction (e.g. when the customer conducts a transaction with another vendor entity at a later point in time). Similarly, a merchant in a particular transaction may be the vendor in another transaction.

Sales data of a customer relating to a merchant may include one or more of the following:
merchant identity data representing a unique identifier for the vendor (e.g. based on the vendor identity data for that vendor) that conducted the sales transaction with the customer;
merchant category data representing a category for the vendor (e.g. based on the vendor category data for that vendor) that conducted the sales transaction with the customer;
visits data representing a cumulative (total) number of visits to the merchant by the customer;
amount data representing a cumulative (total) value of sales transactions between the customer and the merchant; and
last update data representing the date of the most recent visit to the merchant by the customer.

Each of the POS terminals 106a, 106b and 106c separately generates the relationship data for each vendor, based on the sales data for the respective customers of that vendor. Alternatively, the promotions server 102 may be used to generate the relationship data for each vendor and then transmit it to the relevant POS terminal 106a, 106b and 106c. The relationship data for a vendor represents one or more attributes of each of the merchants that have previously completed sales transactions with the customers of that vendor. The relationship data may include one or more entries, each entry including values for one or more different attributes for a particular merchant.

TABLE 4

| | | | | Total card | Last |
|---|---|---|---|---|---|
| | | Monetary | | trans- | update |
| | Frequency | amount | Recency | actions | date |
| Merchant 1 | F₁ | M₁ | R₁ | T₁ | U₁ |
| Merchant 2 | F₂ | M₂ | R₂ | T₂ | U₂ |
| Merchant n | Fₙ | Mₙ | Rₙ | Tₙ | Uₙ |

Table 4 shows an example of the relationship data generated for a vendor, which includes:
frequency data representing an average number of visits to a relevant merchant by one or more different customers of the vendor. This relates to values in the frequency column in Table 4. The higher the value of this relationship score, the greater (or stronger) the relationship between the relevant merchant and the vendor;
cumulative spend data representing an average value of the sales transactions between (for different merchants) a particular merchant and the different customers of the vendor. This relates to the values in the monetary amount column in Table 4. The higher the value of this relationship score, the greater (or stronger) the relationship between the relevant merchant and the vendor;
recency data representing (for different merchants) an average duration (e.g. in number of days) based on the vendor's customers' most recent visit to a particular merchant and the customers' most recent visit to the vendor. This relates to the values in the recency column in Table 4. The lower the value of this relationship score, the greater (or stronger) the relationship between the relevant merchant and the vendor;
total transactions data representing (for different merchants) a total number of sales transactions between the vendor's customers and a particular merchant. This number is generated based on the visits data for different customers of the vendor, and involves adding the value represented by the visits data for a customer with the existing value represented by the total transactions data for a merchant. This relates to the values in the total card transactions column in Table 4; and
relationship last update data representing the date on which any of the above fields in the vendor's relationship data were updated for the relevant merchant.

The POS terminal 106a, 106b and 106c generates frequency data for a merchant based on Equation 1. After each sales transaction, the POS terminal 106a, 106b and 106c generates an average based on the value represented by the visits data for a customer and the existing value represented by the current frequency data for the merchant. The frequency data for the merchant represents the quotient (F_{new}) of a sales total, representing the total number of visits to the merchant by the vendor's customers, and the total number of sales transactions between those customers and the vendor. In other words, the average value (F_{new}) generated by POS terminals based on Equation 1 is the total visits value divided by total number of sales transactions for that merchant.

$${F}_{new} = \frac{( {F}_{current} \times {N}_{current} ) + {V}_{sales data}}{{N}_{current} + 1} \qquad Equation 1$$

In Equation 1, F_{current} represents the existing value represented by the frequency data for the relevant merchant, N_{current} represents the existing value represented by the total transactions data for the relevant merchant, and V_{sales data} represents the value represented by the visits data for the customer.

The POS terminal 106a, 106b and 106c generates cumulative spend data for a merchant based on Equation 2. After each sales transaction, the POS terminal generates an average based on the value represented by the amount data for a customer and the existing value represented current cumulative spend data for the merchant. The cumulative spend data for the merchant represents the quotient (CS_{new}) of a spend total, representing the total value of the sales transactions between the vendor's customers and the merchant, and the total number of sales transactions between those customers and the vendor. In other words, the average value (CS_{new}) generated by POS terminals based on Equation 2 is the total sales amount value divided by total number of sales transactions for that merchant.

$${CS}_{new} = \frac{( {CS}_{current} \times {N}_{current} ) + {A}_{sales data}}{{N}_{current} + 1} \qquad Equation 2$$

In Equation 2, CS_{current} represents the existing value represented by the cumulative spend data for the relevant merchant, N_{current} represents the existing value represented by the total transactions data for the relevant merchant, and A_{sales data} represents the value represented by the amount data for the customer.

The POS terminal 106a, 106b and 106c generates recency data for a merchant based on Equations 3 and 4. After each sales transaction, the POS terminal generates a recency counter value based on Equation 3, and generates an average based on the value represented by the current recency counter value with the existing recency counter value for the merchant based on Equation 4. The recency data for the merchant represents the quotient (R_{new}) of a total period, representing a total of the times between the customers' most recent visit to the merchant and those customers' most recent visit to the vendor, and the total number of sales transactions between said customers and said vendor. In other words, the average value (R_{new}) generated by the POS terminals based on Equation 4 is the total recency value divided by total number of sales transactions for that merchant.

$$\begin{matrix}{R}_{recency counter} = ( current date ) - ( {L}_{sales data} ) & Equation 3 \\ {R}_{new} = \frac{( {R}_{current} \times {N}_{current} ) + {R}_{recency counter}}{{N}_{current} + 1} & Equation 4\end{matrix}$$

In Equations 3 and 4, L_{sales data} represents the date represented by the last update data for the customer, R_{current} represents the existing value represented by the cumulative spend data for the relevant merchant, and N_{current} represents the existing value represented by the total transactions data for the relevant merchant.

FIG. 2 shows a flow diagram of a promotions process 200 performed by each processor of a POS terminal 106a, 106b and 106c under the control of a respective control module. Process 200 begins at step 202 where the POS terminal 106a, 106b and 106c processes the payment authorisation and completes the payment process between the vendor and the customer. For example, this involves swiping a customer's client device 108 (e.g. an electronic chip card) through the POS terminal 106a, 106b and 106c to complete a payment transaction.

At step 204, the POS terminal 106a, 106b, 106c (under the control of process 300) reads the client device 108 and creates and/or updates the sales data stored on the client device 108 (or alternatively, stored on the database 104) to include details based on the present sales transaction between the vendor and the customer. For example, this involves the POS terminal 106a, 106b, 106c first reading the customer's client device 108 to check if the sales data includes an entry for the present vendor. If not, the POS terminal 106a, 106b, 106c creates an additional entry in the customer's sales data and stores sales data specific to the recent sales transaction completed at that vendor. If the sales data already includes an entry for that vendor, the data in that entry is updated by:
increasing the value represented by the visits data by 1;
increasing the value represented by the amount data by the total purchase amount approved; and
updating the date represented by the last update data to the current date (i.e. the date on the transaction was carried out);

At step 206, the POS terminal 106a, 106b, 106c (under the control of process 400) generates or updates, based on the sales data for one or more different customers of that vendor, relationship data for the vendor corresponding to that POS terminal. For example, this involves the POS terminal 106a, 106b, 106c reading the sales data from the customer's client device 108 and updating the vendor's relationship data based on the sales data for that customer. This could involve the following steps:
Each entry of the customer's sales data corresponding to a merchant (except the entry corresponding to the present vendor) is accessed one by one, and the entry in the vendor's relationship data corresponding to those respective merchants are updated using an appropriate scoring mechanism.
If the vendor's relationship data does not include an entry for one of those merchants, a new entry is added to the relationship data and new relationship values for that entry are generated.
If the merchant category data for one of the merchants represented in the customer's sales data is not defined by the vendor rules data as a category that the vendor wants to run cross-promotions with (e.g. a competitive merchant category), then the sales data for that merchant is ignored.
At the end of this step, an exclude list (ExL) is generated.

Thus, as new card transactions happen at the vendor's POS terminal, the vendor's relationship data becomes progressively richer to reflect the behaviour of different customers. Targeted cross-promotions then can be drawn from this information.

At step 208, the POS terminal 106a, 106b, 106c (under the control of process 500) selects one or more merchants based on the relationship data and criteria data for the vendor. This involves ranking the merchants represented in the vendor's relationship data according to various criteria (e.g. a frequency criteria, cumulative amount spent criteria, and recency criteria) to take into account the vendor's customer's shopping pattern. The ranking of the merchants is based on the parameter values represented by the transaction limit data and selection limit data defined during the registration process.
For a merchant to qualify within the Top[n] bracket (where the value of n is defined by the selection limit data), it has to satisfy the minimum number of sales transaction defined by the transaction limit data; and
For each category (i.e. Frequency, Amount and Recency), the Top[n] merchants are selected based on the values in the vendor's relationship data. For the frequency and amount categories, a higher value represents a stronger relationship between the vendor and merchant. For the recency category, a lower value represents a stronger relationship.

At step 210, the POS terminal 106a, 106b, 106c (under the control of process 600) accesses promotions data for the merchants selected at step 208 and then generates, based on the promotions data, a record (e.g. a printed coupon) of the promotions. This involves determining whether, based on the customer's sales data, that customer is relevant to the vendor by checking if the minimum matching conditions are satisfied. Each of the categories (i.e. frequency, amount and recency types) is evaluated individually. This is achieved by comparing the Top[n] merchants in each category (generated in step 208) and the exclude list (ExL) generated in step 206. The parameters used in this are the values represented by the frequency match data, amount match data and recency match data as defined during the registration process. If the customer is determined to be relevant based on this analysis, the POS terminal 106a, 106b, 106c preferably accesses and prints promotions data for those merchants that the customer is likely to visit but has not visited before. Process 200 ends after step 210.

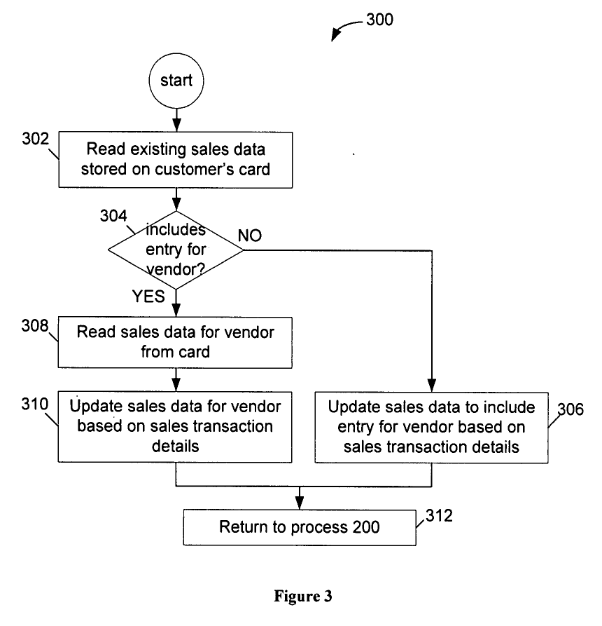

FIG. 3 shows a flow diagram of a customer update process 300 performed by the POS terminals 106a, 106b, 106c. Process 300 begins at step 302 where the POS terminal 106a, 106b, 106c reads the sales data stored on the customer's client device 108 (e.g. a smart card). At step 304, the POS terminal 106a, 106b, 106c determines whether the sales data for the customer includes sales data for the vendor. If not, step 304 proceeds to step 306 where the POS terminal 106a, 106b, 106c updates the existing sales data stored on the customer's client device 108 to include the details of the vendor (e.g. based on the details of the sales transaction between the vendor and the customer). Otherwise, step 304 proceeds to step 308 to read the sales data corresponding to the vendor. At step 310, the POS terminal 106a, 106b, 106c updates the values represented in the sales data for that vendor based on the details of the sales transaction between the vendor and the customer. Steps 306 and 310 both proceed to step 312, where process 200 resumes control of the POS terminal 106a, 106b, 106c.

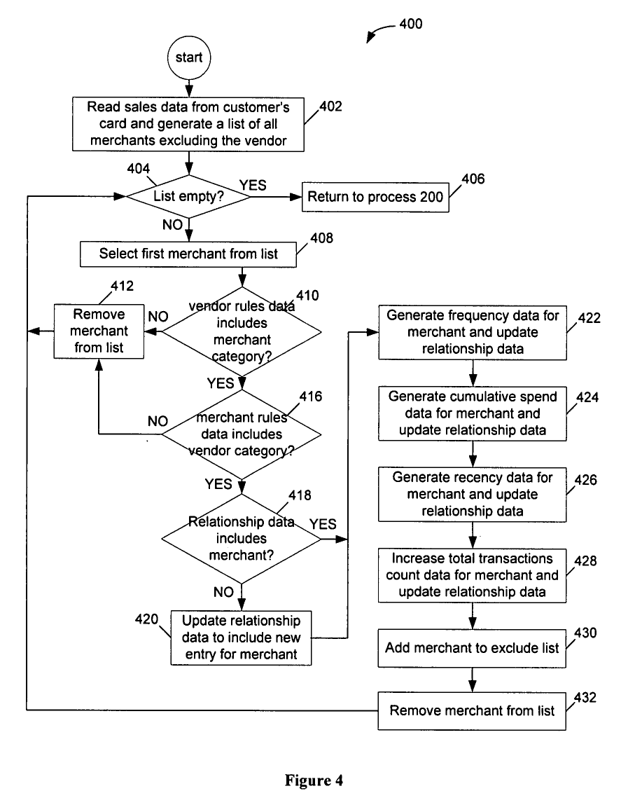

FIG. 4 shows a flow diagram of a relationship analysis process 400 performed by the POS terminals 106a, 106b, 106c. Process 400 begins at step 402, where the POS terminal 106a, 106b, 106c read sales data from the customer's client device 108 and generates a merchant list including all of the merchants represented in the sales data (excluding the present vendor). At step 404, the merchant list is reviewed to determine if it is empty. If so, step 404 proceeds to step 406, where process 200 resumes control of the POS terminal 106a, 106b, 106c. Otherwise step 404 proceeds to step 408 to select the first merchant from the merchant list.

At step 410, the POS terminal 106a, 106b, 106c compares the vendor rules data for the vendor and the merchant category data for the merchant selected at step 408. If the category for the merchant selected at step 408 (based on the merchant category data) belongs to one of the permitted categories defined in the vendor rules data, then step 410 proceeds to step 416. Otherwise, step 410 proceeds to step 412 to remove the selected merchant from the merchant list. Step 412 then proceeds to step 404.

At step 416, the POS terminal 106a, 106b, 106c compares the merchant rules data for the merchant selected at step 408 and the vendor category data for the vendor. If the category for the vendor (based on the vendor category data) belongs to one of the permitted categories defined in the merchant rules data, then step 416 proceeds to step 418. Otherwise, step 416 proceeds to step 412.

At step 418, the POS terminal 106a, 106b, 106c accesses the vendor's relationship data and determines whether the relationship data includes an entry corresponding to the merchant selected at step 408. If so, step 418 proceeds to step 422. Otherwise, step 418 proceeds to step 420 where the POS terminal 106a, 106b, 106c updates the vendor's relationship data to include a new entry for the merchant. Step 420 proceeds to step 422.

At step 422, the POS terminal 106a, 106b, 106c generates or updates the value represented by the frequency data for the selected merchant based on Equation 1. At step 424, the POS terminal 106a, 106b, 106c generates or updates the value represented by the cumulative spend data for the selected merchant based on Equation 2. At step 426, the POS terminal 106a, 106b, 106c generates or updates the value represented by the recency data for the selected merchant based on Equations 3 and 4. At step 428, the POS terminal 106a, 106b, 106c increases the value represented by the total transaction data for the selected vendor by 1.

At step 430, the selected merchant is added to an exclude list ([ExL]) for further processing. At step 432, the selected merchant is removed from the merchant list, and step 432 then proceeds to step 404.

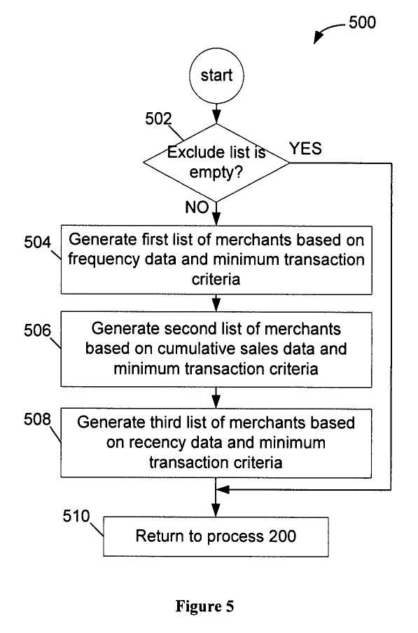

FIG. 5 shows a flow diagram of a selection process 500 performed by the POS terminals 106a, 106b, 106c. Process 500 begins at step 502 by reviewing the exclude list to determine if it is empty. If so, step 502 proceeds to step 510 where process 200 resumes control of the POS terminal 106a, 106b, 106c. Otherwise, step 502 proceeds to step 504.

At step 504, the POS terminal 106a, 106b, 106c generates a first list representing one or more merchants from the exclude list, where those merchants are selected based on the frequency data and the minimum transaction criteria. This involves ranking the merchants from the exclude list (which are also defined in the relationship data) from highest to lowest based on the values represented by the respective frequency data for those merchants. The ranking disregards merchants with a value represented by the corresponding total transaction data that exceeds or equals the value represented by the transaction limit data. The POS terminal 106a, 106b, 106c then generates a first list representing a selection of one or more of the merchants from the exclude list in the order as ranked starting from the merchant with the highest value as represented by the corresponding frequency data, wherein the number of merchants in the first list does not exceed the number represented by the selection limit data. Step 504 then proceeds to step 506.

At step 506, the POS terminal 106a, 106b, 106c generates a second list representing one or more merchants from the exclude list, where those merchants are selected based on the cumulative sales data and minimum transaction criteria. This involves ranking the merchants from the exclude list (which are also defined in the relationship data) from highest to lowest based on the values represented by the respective cumulative spend data for those merchants. The ranking disregards merchants with a value represented by the corresponding total transaction data that exceeds or equals the value represented by the transaction limit data. The POS terminal 106a, 106b, 106c then generates a second list representing a selection of one or more of the merchants from the exclude list in the order as ranked starting from the merchant with the highest value as represented by the corresponding cumulative spend data, wherein the number of merchants in the second list does not exceed the number represented by the selection limit data. Step 506 then proceeds to step 508.

At step 508, the POS terminal 106a, 106b, 106c generates a third list representing one or more merchants from the exclude list, where those merchants are selected based on the recency data and minimum transaction criteria. This involves ranking the merchants from the exclude list (which are also defined in said relationship data) from lowest to highest based on the values represented by the respective recency data for those merchants. The ranking disregards merchants with a value represented by the total transaction data that exceeds or equals the value represented by the transaction limit data. The POS terminal 106a, 106b, 106c then generates a third list representing a selection of one or more of the merchants from the exclude list in the order as ranked starting from the merchant with the lowest value as represented by the corresponding recency data, wherein the number of merchants in said third list does not exceed the number represented by the selection limit data. Step 508 then proceeds to step 510.

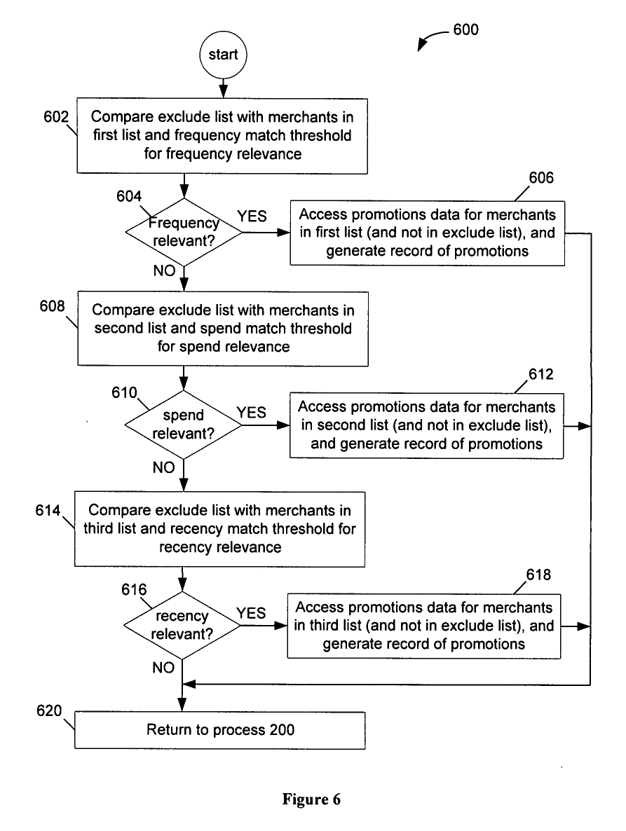

FIG. 6 shows a flow diagram of a presentation process 600 performed by the POS terminals 106a, 106b, 106c. Process 600 begins at step 602, where the POS terminal 106a, 106b, 106c compares the merchants in the exclude list and the first list for relevance in the frequency category. This comparison involves determining whether the exclude list includes at least a minimum number of merchants also in the first list, the minimum number being the frequency match threshold represented by the frequency match data defined by the vendor during registration. If so, step 604 determines the customer to be relevant in the frequency category, and step 604 proceeds to step 606 to access promotions data for the merchants in the first list (excluding those for the present vendor) and generates a record of those promotions for the customer (e.g. print coupons based on the promotions data, or store the promotions as data on the customer's client device 108). Preferably, step 606 only accesses promotions data for relevant merchants in the first list that are not in the exclude list (i.e. those merchants that the customer has not visited, for example, as defined in Table 5). If step 604 determines that the customer is not relevant in the frequency category, then step 604 proceeds to step 608.

At step 608, the POS terminal 106a, 106b, 106c compares the merchants in the exclude list and the second list for relevance in the cumulative spend category. This comparison involves determining whether the exclude list includes at least a minimum number of merchants also in the second list, the minimum number being the spend match threshold represented by the spend match data defined by the vendor during registration. If so, step 610 determines the customer to be relevant in the cumulative spend category, and step 610 proceeds to step 612 to access promotions data for the merchants in the second list (excluding those for the present vendor) and generates a record of those promotions for the customer. Preferably, step 612 only accesses promotions data for relevant merchants in the second list that are not in the exclude list (i.e. those merchants that the customer has not visited, for example, as defined in Table 5). If step 610 determines that the customer is not relevant in the spend category, then step 610 proceeds to step 614.

At step 614, the POS terminal 106a, 106b, 106c compares the merchants in the exclude list and the third list for relevance in the recency category. This comparison involves determining whether the exclude list includes at least a minimum number of merchants also in the third list, the minimum number being the recency match threshold represented by the recency match data defined by the vendor during registration. If so, step 616 determines the customer to be relevant in the recency category, and step 616 proceeds to step 618 to access promotions data for the merchants in the third list (excluding those for the present vendor) and generates a record of those promotions for the customer. Preferably, step 618 only accesses promotions data for relevant merchants in the third list that are not in the exclude list (i.e. those merchants that the customer has not visited, for example, as defined in Table 5). Otherwise, step 616 proceeds to step 620 where process 200 resumes control of the POS terminal 106a, 106b, 106c.

TABLE 5

| | Card | |
|---|---|---|
| Case # | Relevancy | Description |
| Case-1 | Card | [ExL] satisfies the minimum condition |
| | Relevant | (MinMatch)_{Frequency} |
| | | All the merchants that are in the Top[n] |
| | | but not in [ExL] are recommended to the |
| | | cardholder & cross-promotions printed |
| Case-2 | Card | [ExL] satisfies the minimum condition |
| | Relevant | (MinMatch)_{Frequency} |
| | | All the merchants that are in the Top[n] |
| | | but not in [ExL] are recommended to the |
| | | cardholder & cross-promotions printed |
| Case-3 | Card NOT | [ExL] DOES NOT satisfy the minimum |
| | Relevant | condition (MinMatch)_{Frequency} |
| Case-4 | Card NOT | All the merchants are already present in the |
| | Relevant | [ExL]. No new merchants to recommend. |
| Case-5 | Card NOT | [ExL] DOES NOT satisfy the minimum |
| | Relevant | condition (MinMatch)_{Frequency}. |

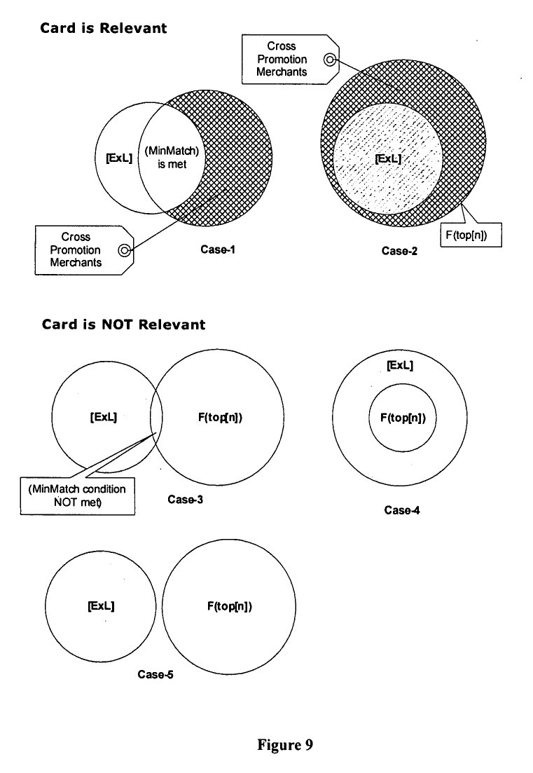

The exemplary cases referred to in Table 5 relate to comparisons based on the frequency category, and can be better understood with reference to the corresponding Venn diagrams shown in FIG. 9.

FIG. 8 is block diagram showing an exemplary application of the promotions system 100, the numbered steps of which are described in Table 6, which assumes that:
Merchant-A is a courier company and a Promotion Sponsor Merchant (PSM) (or vendor). His promotions can be distributed at GM Discount stores and Dining & Fast Food outlets;
Merchant-B is GM Discount store and a Promotion Distributor Merchant (PDM) (or merchant). He can distribute promotions by Courier companies and Fast Food outlets;
Merchant-C is a Food outlet and a PSM. His promotions can be distributed at GM Discount stores and Courier companies; and

the POS terminal 106a, 106b 106c is a card accepting device at a point of sales.

TABLE 6

| # | Description of the steps |
|---|---|
| 1. | First cardholder (C/h-l) does a transaction at Merchant-A |
| 2. | The CF software operates during the transaction. No cross- |
| | promotions are generated. The MR matrix at Merchant's A |
| | POS is updated with C/h-l behaviour data. |
| 3. | C/h-l does a transaction at Merchant-B |
| 4. | The CF software operates during the transaction. No cross- |
| | promotions are generated. The MR matrix at Merchant's B |
| | POS is updated with C/h-l behaviour data. |
| 5. | Second cardholder (C/h-2) does a transaction at Merchant-C |
| 6. | The CF software operates during the transaction. No cross- |
| | promotions are generated. The MR matrix at Merchant's C |
| | POS is updated with C/h-2 behaviour data. |
| 7. | C/h-2 does a transaction at Merchant-B |
| 8. | The CF software operates during the transaction. Cross- |
| | promotion is generated. The MR matrix at Merchant's B |
| | POS is updated with C/h-2 behaviour data. |
| 9. | The Cross-promotion is printed along with the payment |
| | receipt at the end of the transaction. |

The promotions system 100 enables propagation of the shopping pattern of customers from one POS terminal 106a, 106b, 106c of a vendor to another via a client device 108 such as an electronic chip card. In one sense, an analogy could be made between the client device 108 acting like a network by transporting data from one POS terminal 106a, 106b, 106c to another (similar to a virus that spreads itself). Preferably, the analysis performed at each POS terminal 106a, 106b, 106c is based on a CF technique (as described above), thus making the client devices 108 themselves the network without the need for the central server to carry out the transaction data analysis.

Sales data read from a customer's client device 108 is typically fed into a merchant relationship (MR) matrix (represented by the vendor's relationship data) so that the CF analysis and other software operations can be carried out offline within the POS terminal 106a, 106b, 106c at the moment of purchase. By performing a simple CF analysis of the MR matrix, the POS terminal 106a, 106b, 106c is able to identify a list of merchants that other cardholders with similar profile (to the current payee) have visited but which this payee has never visited.

The CF analysis performed by the promotions system 100 includes a merchant relationship scoring mechanism that can be computed efficiently and thus fitted into the limited memory of a POS terminal 106a, 106b, 106c (which usually has a small amount of memory available). The dimensions (i.e. attributes) relating to merchants in the MR matrix limit the number of merchants by constantly discarding merchants with low activity in the MR matrix.

Accordingly, the data transaction information and results of the CF analysis can be used by the merchant to set up further automated cross promotions and discover new merchants who are frequented by the customer and thus of interest for further cross-promotions. Furthermore, the promotions system 100 enhances the payee payment experience, for example, by allowing merchants to discover new cross-promotion opportunities by analysing the customer's sales transaction data and enable customers to discover new merchants that are relevant to their interests.

Thus the promotions system 100 enables CF technique to be used to achieve automatic targeted cross-promotions between merchants so as to:
allow merchants to discover new cross-promotion opportunities by analysing the sales data of a customer;
setup these cross-promotions automatically;
target the cross-promotions to the relevant customers (rather than all customers); and
allow customers to discover new merchants that are relevant to their interests.

The cross-promotion systems of the prior art include systems that only allow two separate merchants to create a cross-promotion encouraging one party's customers to visit the other party's store, by virtue of the two merchants agreeing on the details of the promotion. By contrast, the promotions system 100 makes it possible for the two merchants to remain separate without the need to enter into an agreement. That is, promotion distributors do not need to know the identity of the promotion sponsors, and vice versa. Thus cross promotions become completely automatic and can be targeted to the relevant customers.

The promotions system 100 also permits automation of cross-promotions for the merchant. The merchant simply picks the category of merchants (e.g. Retail, Fast Food, Grocery, Petrol etc) with whom they want to run cross-promotions. That is all that is needed by the way of set-up. The promotions system enables the automatic matching of the mutual interests of vendors and merchants by finding the intersection between the two.

Modifications and improvements to the invention will be readily apparent to those skilled in the art. Such modifications and improvements are intended to be within the scope of this invention. For example, the processes performed by the POS terminals 106a, 106b and 106c can be performed on the promotions server 102 and then transmitted to the respective POS terminals for further processing (e.g. transmits the relevant promotions data to the relevant POS terminals for printing the relevant coupons).

The word ‘comprising’ and forms of the word ‘comprising’ as used in this description and in the claims does not limit the invention claimed to exclude any variants or additions.

1. A promotional system including a point-of-sales terminal for a vendor, said terminal being configured to:
i) access sales data representing previous sales transactions of a customer of said vendor with different merchants;
ii) generate, based on said sales data, relationship data representing one or more attributes of said merchants;
iii) access configuration data including data representing one or more criteria for providing one or more promotions of one or more of said merchants to said customer based on said attributes;
iv) select, based on said relationship data and said configuration data, one or more of said merchants with at least one of said attributes that satisfy said criteria;
v) access promotions data representing said one or more promotions for said selected merchants; and
vi) generate, based on said promotions data, a record of said one or more promotions for said customer.

2. A system as claimed in claim 1, wherein said configuration data includes merchant data for different said merchants, the merchant data for one of said merchants including:
merchant identity data representing a unique identifier for said merchant;
merchant category data representing, based on several predefined categories of merchants, at least one of said categories related to the type of goods or services provided by said merchant; and
merchant rules data representing one or more of said predefined categories related to the goods or services provided by a said vendor that is permitted to provide said promotions of said merchant.

3. A system as claimed in claim 2, wherein said configuration data includes vendor data including:
vendor identity data representing a unique identifier for said vendor;
vendor category data representing at least one of said predefined categories related to the type of goods or services provided by said vendor; and
vendor rules data representing one or more of said predefined categories, wherein said vendor provides only promotions of those said merchants associated with the categories defined in said merchant category data and said vendor rules data.

4. A system as claimed in claim 1, wherein said sales data for said customer with one of said merchants includes:
visits data representing a total number of visits to said merchant by said customer;
amount spend data representing a total value of sales transactions between said customer and said merchant; and
last update data representing the date of the most recent visit to said merchant by said customer.

5. A system as claimed in claim 1, wherein said relationship data for one of said merchants includes:
frequency data representing an average number of visits to said merchant by one or more different customers of said vendor;
cumulative spend data representing an average value of the sales transactions between said merchant and said customers of said vendor;
recency data representing an average duration based on said customers' most recent visit to said merchant and said customers' most recent visit to said vendor; and
total transactions data representing a total number of sales transactions between said customers and said merchant.

6. A system as claimed in claim 5, wherein said frequency data for said merchant represents the quotient of a sales total, representing the total number of visits to said merchant by said customers, and the total number of sales transactions between said customers and said vendor.

7. A system as claimed in claim 5, wherein said cumulative spend data for said merchant represents the quotient of a spend total, representing the total value of the sales transactions between different said customers at said merchant, and the total number of sales transactions between said customers and said vendor.

8. A system as claimed in claim 5, wherein said recency data for said merchant represents a quotient of a total period, representing a total of the times between said customers' most recent visit to said merchant and said customers' most recent sales to said vendor, and the total number of sales transactions between said customers and said vendor.

9. A system as claimed in claim 5, wherein said configuration data includes:
transaction limit data representing a minimum number of said average number of sales transactions between said different customers and any one of said merchants for that customer to qualify for said promotions from one of said merchants; and
selection limit data representing a maximum number of said merchants for selection.

10. A system as claimed in claim 9, wherein said step (iv) includes:
ranking said merchants defined in said relationship data from highest to lowest based on the values represented by the respective frequency data for said merchants, said ranking disregarding merchants with a value represented by said total transaction data that exceeds or equals the value represented by said transaction limit data; and
generating a first selection of one or more of said merchants in the order as ranked starting from the merchant with the highest value as represented by said frequency data, wherein the number of merchants in said first selection does not exceed the number represented by said selection limit data.

11. A system as claimed in claim 10, wherein said configuration data includes frequency match data representing a first threshold number, and said steps (v) and (vi) are performed only if said sales data for said customer includes at least said first threshold number of merchants included in said first selection.

12. A system as claimed in claim 9, wherein said step (iv) includes:
ranking said merchants defined in said relationship data from highest to lowest based on the values represented by the respective cumulative spend data for said merchants, said ranking disregarding merchants with a value represented by said total transaction data that exceeds or equals the value represented by said transaction limit data; and
generating a second selection of one or more of said merchants in the order as ranked starting from the merchant with the highest value as represented by said cumulative spend data, wherein the number of merchants in said second selection does not exceed the number represented by said selection limit data.

13. A system as claimed in claim 12, wherein said configuration data includes spend match data representing a second threshold number, and said steps (v) and (vi) are performed only if said sales data for said customer includes at least said second threshold number of merchants included in said second selection.

14. A system as claimed in claim 9, wherein said step (iv) includes:
ranking said merchants defined in said relationship data from lowest to highest based on the values represented by the respective recency data for said merchants, said ranking disregarding merchants with a value represented by said total transaction data that exceeds or equals the value represented by said transaction limit data; and
generating a third selection of one or more of said merchants in the order as ranked starting from the merchant with the lowest value as represented by said recency data, wherein the number of merchants in said third selection does not exceed the number represented by said selection limit data.

15. A system as claimed in claim 14, wherein said configuration data includes recency match data representing a third threshold number, and said steps (v) and (vi) are performed only if said sales data for said customer includes at least said third threshold number of merchants included in said third selection.

16. A system as claimed in claim 1, wherein said promotions data includes description data representing text or graphics relating to a commercial offer, a monetary reward or a discount for a sales transaction.

17. A system as claimed in claim 1, wherein said reward only relates to said merchants not included in said sales data for said customer.

18. A promotional method including:
i) accessing sales data representing previous sales transactions of a vendor's customer with different merchants;
ii) generating, based on said sales data, relationship data representing one or more attributes of said merchants;
iii) accessing configuration data including data representing one or more criteria for providing one or more promotions of one or more of said merchants to said customer based on said attributes;
iv) selecting, based on said relationship data and said configuration data, one or more of said merchants with at least one of said attributes that satisfy said criteria;
v) accessing promotions data representing said one or more promotions for said selected merchants; and
vi) generating, based on said promotions data, a record of said one or more promotions for said customer.

19. A method as claimed in claim 18, wherein said configuration data includes merchant data for different said merchants, the merchant data for one of said merchants including:
merchant identity data representing a unique identifier for said merchant;
merchant category data representing, based on several predefined categories of merchants, at least one of said categories related to the type of goods or services provided by said merchant; and
merchant rules data representing one or more of said predefined categories related to the goods or services provided by a said vendor that is permitted to provide said promotions of said merchant.

20. A method as claimed in claim 19, wherein said configuration data includes vendor data including:
vendor identity data representing a unique identifier for said vendor;
vendor category data representing at least one of said predefined categories related to the type of goods or services provided by said vendor; and
vendor rules data representing one or more of said predefined categories, wherein said vendor provides only promotions of those said merchants associated with the categories defined in said merchant category data and said vendor rules data.

21. A method as claimed in claim 18, wherein said sales data for said customer with one of said merchants includes:
visits data representing a total number of visits to said merchant by said customer;
amount spend data representing a total value of sales transactions between said customer and said merchant; and
last update data representing the date of the most recent visit to said merchant by said customer.

22. A method as claimed in claim 18, wherein said relationship data for one of said merchants includes:
frequency data representing an average number of visits to said merchant by one or more different customers of said vendor;
cumulative spend data representing an average value of the sales transactions between said merchant and said customers of said vendor;
recency data representing an average duration based on said customers' most recent visit to said merchant and said customers' most recent visit to said vendor; and
total transactions data representing a total number of sales transactions between said customers and said merchant.

23. A method as claimed in claim 22, wherein said frequency data for said merchant represents the quotient of a sales total, representing the total number of visits to said merchant by said customers, and the total number of sales transactions between said customers and said vendor.

24. A method as claimed in claim 22, wherein said cumulative spend data for said merchant represents the quotient of a spend total, representing the total value of the sales transactions between different said customers at said merchant, and the total number of sales transactions between said customers and said vendor.

25. A method as claimed in claim 22, wherein said recency data for said merchant represents a quotient of a total period, representing a total of the times between said customers' most recent visit to said merchant and said customers' most recent sales to said vendor, and the total number of sales transactions between said customers and said vendor.

26. A method as claimed in claim 22, wherein said configuration data includes:
transaction limit data representing a minimum number of said average number of sales transactions between said different customers and any one of said merchants for that customer to qualify for said promotions from one of said merchants; and
selection limit data representing a maximum number of said merchants for selection.

27. A method as claimed in claim 26, wherein said step (iv) includes:
ranking said merchants defined in said relationship data from highest to lowest based on the values represented by the respective frequency data for said merchants, said ranking disregarding merchants with a value represented by said total transaction data that exceeds or equals the value represented by said transaction limit data; and
generating a first selection of one or more of said merchants in the order as ranked starting from the merchant with the highest value as represented by said frequency data, wherein the number of merchants in said first selection does not exceed the number represented by said selection limit data.

28. A system as claimed in claim 27, wherein said configuration data includes frequency match data representing a first threshold number, and said steps (v) and (vi) are performed only if said sales data for said customer includes at least said first threshold number of merchants included in said first selection.

29. A system as claimed in claim 26, wherein said step (iv) includes:
ranking said merchants defined in said relationship data from highest to lowest based on the values represented by the respective cumulative spend data for said merchants, said ranking disregarding merchants with a value represented by said total transaction data that exceeds or equals the value represented by said transaction limit data; and
generating a second selection of one or more of said merchants in the order as ranked starting from the merchant with the highest value as represented by said cumulative spend data, wherein the number of merchants in said second selection does not exceed the number represented by said selection limit data.

30. A system as claimed in claim 29, wherein said configuration data includes spend match data representing a second threshold number, and said steps (v) and (vi) are performed only if said sales data for said customer includes at least said second threshold number of merchants included in said second selection.

31. A system as claimed in claim 26, wherein said step (iv) includes:
ranking said merchants defined in said relationship data from lowest to highest based on the values represented by the respective recency data for said merchants, said ranking disregarding merchants with a value represented by said total transaction data that exceeds or equals the value represented by said transaction limit data; and
generating a third selection of one or more of said merchants in the order as ranked starting from the merchant with the lowest value as represented by said recency data, wherein the number of merchants in said third selection does not exceed the number represented by said selection limit data.

32. A method as claimed in claim 31, wherein said configuration data includes recency match data representing a third threshold number, and said steps (v) and (vi) are performed only if said sales data for said customer includes at least said third threshold number of merchants included in said third selection.

33. A method as claimed in claim 18, wherein said promotions data includes description data representing text or graphics relating to a commercial offer, a monetary reward or a discount for a sales transaction.

34. A method as claimed in claim 18, wherein said reward only relates to said merchants not included in said sales data for said customer.

35. A method as claimed in claim 18 used in a point-of-sales terminal.

36. Computer readable code for configuring a point-of-sales device to perform a method as claimed in claim 18.
